(19) United States
(12) Patent Application Publication
(10) Pub. No.: US 2012/0268786 A1
(43) Pub. Date: Oct. 25, 2012

(54) RECORDING DEVICE, METHOD OF CONTROLLING A RECORDING DEVICE, AND STORAGE MEDIUM STORING A PROGRAM RUN BY A CONTROL UNIT THAT CONTROLS A RECORDING DEVICE

(75) Inventor: Makoto Noguchi, Shiojiri-shi (JP)

(73) Assignee: SEIKO EPSON CORPORATION, Tokyo (JP)

(21) Appl. No.: 13/451,729

(22) Filed: Apr. 20, 2012

(30) Foreign Application Priority Data
Apr. 20, 2011 (JP) 2011-093578

(51) Int. Cl. G06F 3/12; G06K 15/02

(52) U.S. Cl. 358/1.15

(57) ABSTRACT

Processing delays are prevented even when the number of processes executed to control a recording device increases. The printer-side control unit of a recording device having plural devices includes a drive control unit that drives the device by executing a control job; an operating sequence control unit that creates an operating sequence of specific operations; and a job control unit that creates a control job for the device based on the operating sequence. When the operating sequence control unit creates an operating sequence, the job control unit creates a new control job when a control job used in the operating sequence has not been created, and deletes at least one control job when there is a control job that is not used in the operating sequence.

Priority is claimed under 35 U.S.C. §119 to Japanese Application No. 2011-093578 filed on Apr. 20, 2011, which is hereby incorporated by reference in its entirety.

### BACKGROUND

1. Technical Field

The present invention relates to a recording device, a method of controlling the recording device, and a storage medium storing a program.

2. Related Art

The amount of data that is recorded by printers and other recording devices has increased with advances in computer and image processing technologies. This has also increased the processing load of the control device that controls the recording device, created processing delays. Technologies for prioritizing tasks (jobs) performed in conjunction with control of the recording device, and selecting tasks exclusively based on their priority have therefore been developed. See, for example, Japanese Unexamined Patent Appl. Pub. JP-A-2002-011925.

The recording device taught in JP-A-2002-011925 prevents delaying important control operations by selectively executing high priority tasks. However, as recording devices become more complex, the number of tasks may also increase. As the number of tasks increases, more resources are needed, including the need to reserve storage space in memory for pending tasks that have not been completed. As a result, processing efficiency can drop and processing speed can drop when the number of tasks increases significantly.

### SUMMARY

A recording device, a control method for a recording device, and a storage medium storing a program prevent processing delays even when the number of processes performed in conjunction with controlling the recording device increases.

One aspect of the invention is a recording device having plural devices, and including: an operating sequence control unit that creates an operating sequence based on specific operations to be executed; a drive control unit that drives the device by executing a control job; and a job control unit that creates a control job for the device based on the operating sequence, stores the control jobs that are used based on the type of operating sequence created by the operating sequence control unit, and when the operating sequence control unit creates the operating sequence, references the stored control job corresponding to the type of operating sequence, creates a new control job when the control job used in the operating sequence has not been created, and deletes at least one control job when there is a control job that is not used in the operating sequence.

Because this aspect of the invention creates a new control job when a control job that is used in the operating sequence of the recording device has not been created, and deletes at least one control job when there are control jobs that are not used, resources that are occupied by unnecessary control jobs can be freed, and the resources can be used effectively for executing the necessary control jobs. As a result, efficient control is possible without processing being delayed when the process load is high, such as when there is a large amount of data to process, or the recording device has many devices and control is complicated. A device as used herein includes the recording head, actuators, motors, and other operating units that perform operations (drive units), processors such as a CPU that performs operations for controlling the operating units, and memory devices such as ROM and RAM devices used with the CPU for control.

In a recording device according to another aspect of the invention, the job control unit deletes control jobs that are not used so that the number of created control jobs does not exceed a specific threshold.

By deleting control jobs that are not used so that the number of created control jobs does not exceed a specific threshold, this aspect of the invention can reliably allocate more resources to the control jobs that are executed, process delays caused by insufficient resources can be prevented, and processes can be performed quickly.

In a recording device according to another aspect of the invention, a priority of execution is set for the control jobs created by the job control unit; and the drive control unit executes the plural control jobs sequentially or in parallel according to the priority set for each control job.

By deleting control jobs that are not used, this aspect of the invention eliminates the need for a process of changing the priority of control jobs that are not needed but have a high priority setting. As a result, the number of control job management processes can be reduced, and the recording device can be controlled more efficiently.

In a recording device according to another aspect of the invention, the operating sequence control unit creates the operating sequence based on data to be recorded and a control command input to the recording device.

This aspect of the invention enables efficiently controlling the recording device based on the data and control commands input to the recording device.

In a recording device according to another aspect of the invention, the devices include a recording head or actuator; and the job control unit creates one control job for one device.

This aspect of the invention enables reliable device control by generating one control job for one device, and can efficiently control a recording device with many devices by deleting unnecessary jobs.

Another aspect of the invention is a method of controlling a recording device having plural devices, including steps of: creating an operating sequence of specific operations executed by the recording device; referencing previously stored control jobs based on the type of operating sequence created, creating a new control job when the control job used in the operating sequence has not been created, and deleting at least one control job when there is a control job that is not used in the operating sequence; and driving the device by executing the control job.

By executing this control method, this aspect of the invention enables creating a new control job when a control job that is used in the operating sequence of the recording device has not been created, and deleting at least one control job when there are control jobs that are not used. Resources that are occupied by unnecessary control jobs can therefore be freed, and the resources can be used effectively for executing the necessary control jobs. As a result, efficient control is possible without processing being delayed when the process load is high, such as when there is a large amount of data to process, or the recording device has many devices and control is complicated.

Another aspect of the invention is a program that can be executed by a control unit that controls the devices of a recording device having plural devices, the program causing the control unit to function as: a drive control unit that drives the device by executing a control job created for each device; an operating sequence control unit that creates an operating sequence of specific operations executed by the recording device; and a job control unit that stores the control jobs that are used based on the type of operating sequence created by the operating sequence control unit, and when the operating sequence control unit creates the operating sequence, references the stored control job corresponding to the type of operating sequence, creates a new control job when the control job used in the operating sequence has not been created, deletes at least one control job when there is a control job that is not used in the operating sequence, and stores the control jobs.

By running this program, the control unit can create a new control job when a control job that is used in the operating sequence of the recording device has not been created, and delete at least one control job when there are control jobs that are not used. Resources that are occupied by unnecessary control jobs can therefore be freed, and the resources can be used effectively for executing the necessary control jobs. As a result, efficient control is possible without processing being delayed when the process load is high, such as when there is a large amount of data to process, or the recording device has many devices and control is complicated.

Another aspect of the invention is a computer-readable storage medium storing the foregoing program.

### EFFECT OF THE INVENTION

The invention enables using resources effectively, and controlling the recording device efficiently without process delays even when the processing load is high.

### BRIEF DESCRIPTION OF THE DRAWINGS

FIG. 1 shows the configuration of an inkjet line printer according to a preferred embodiment of the invention.

FIG. 2 is a function block diagram of an inkjet line printer.

FIG. 3 shows the functional configuration of the printer control unit.

FIG. 4 shows control jobs related to the operating sequence.

FIG. 5 is a table of control job priority settings.

FIG. 6 describes creating and deleting control jobs.

FIG. 7 is a flow chart of inkjet line printer operation.

### DESCRIPTION OF EMBODIMENTS

A preferred embodiment of the present invention is described below with reference to the accompanying figures.

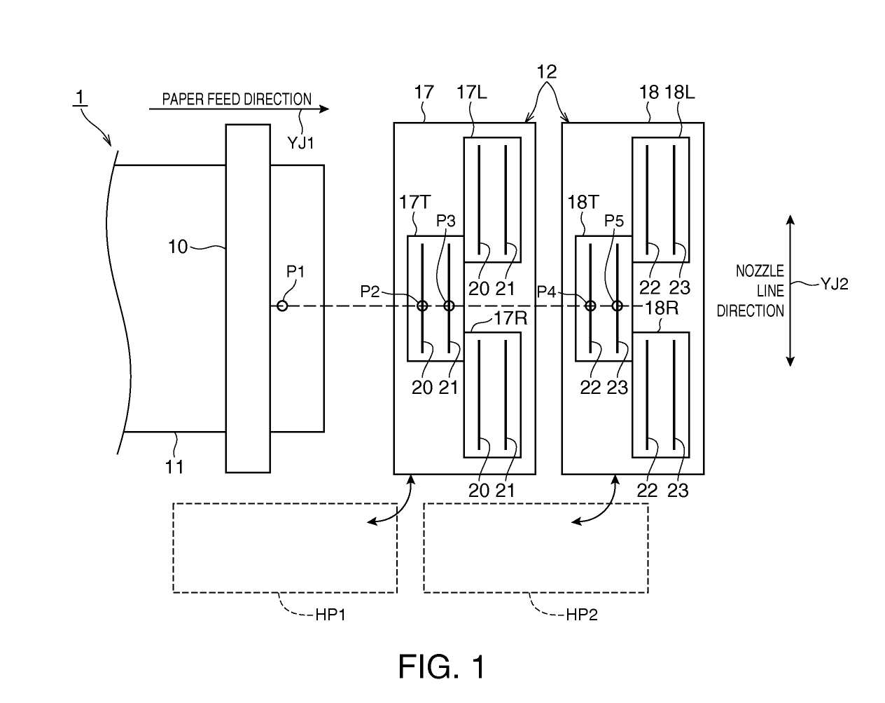

FIG. 1 describes the configuration of an inkjet line printer 1 according to this embodiment of the invention in plan view.

The inkjet line printer 1 used as an example of a recording device in this embodiment is an inkjet printer with a line printhead that records (prints) text, symbols, images, and other markings on a recording medium 11 by ejecting ink from a recording head 12 onto the recording medium 11 while conveying the recording medium 11 in the paper feed direction (indicated by arrow YJ1 in FIG. 1) with a paper feed roller 10.

The recording medium 11 may be a cut sheets of media cut to a specific length, or a continuous sheet medium such as roll paper, or label paper having labels affixed to a continuous liner wound in a roll. This embodiment of the invention is described using roll paper as the recording medium 11.

The recording head 12 includes an upstream head unit 17 located on the upstream side in the conveyance direction of the recording medium 11, and a downstream head unit 18 located on the downstream side.

The upstream head unit 17 has three staggered recording heads, upstream top recording head 17T, upstream left recording head 17L, and upstream right recording head 17R. The downstream head unit 18 similarly has three staggered recording heads, downstream top recording head 18T, downstream left recording head 18L, and downstream right recording head 18R. Each of the recording heads 17T, 17L, 17R, 18T, 18L, 18R has plural nozzle lines. Each nozzle line has a plurality of nozzle holes (nozzles) formed in a line.

A black nozzle line 20 that ejects black (K) ink, and a cyan nozzle line 21 that ejects cyan (C) ink and is disposed downstream from the black nozzle line 20, are disposed to the upstream top recording head 17T.

The black nozzle line 20 is a nozzle line having nozzles (not shown) that eject ink as fine ink droplets formed in the nozzle line direction (indicated by arrow YJ2 in FIG. 1), which is perpendicular to the conveyance direction. The black nozzle line 20 is connected to an ink supply mechanism (not shown) that supplies ink from a black (K) ink cartridge (not shown). The upstream top recording head 17T pushes ink supplied from the black (K) ink cartridge by an actuator such as a piezoelectric device toward the recording medium 11, ejecting fine ink droplets from specific nozzles.

Similarly to the black nozzle line 20, the cyan nozzle line 21 is a nozzle line of nozzles formed in the nozzle line direction, and has ink supplied from a cyan (C) ink cartridge (not shown).

The upstream right recording head 17R and the upstream left recording head 17L are configured identically to the upstream top recording head 17T, and each have a black nozzle line 20, and a cyan nozzle line 21 disposed on the downstream side of the black nozzle line 20.

A magenta nozzle line 22 that ejects magenta (M) ink, and a yellow nozzle line 23 that ejects yellow (Y) ink and is located downstream from the magenta nozzle line 22, are disposed to the downstream top recording head 18T.

Like the black nozzle line 20, the magenta nozzle line 22 is a nozzle line of nozzles formed in the nozzle line direction, and has ink supplied from a magenta (M) ink cartridge (not shown).

Like the black nozzle line 20, the yellow nozzle line 23 is a nozzle line of nozzles formed in the nozzle line direction, and has ink supplied from a yellow (Y) ink cartridge (not shown).

The downstream right recording head 18R and downstream left recording head 18L are configured identically to the downstream top recording head 18T, and each have a magenta nozzle line 22 and a yellow nozzle line 23 disposed on the downstream side of the magenta nozzle line 22.

Note that the recording heads and the nozzle lines of the recording heads are shown as straight lines in plan view in FIG. 1 for convenience of description, but the recording heads are actually configured to eject ink vertically downward from the nozzles of the nozzle lines, and the various parts are disposed to achieve this configuration.

The inkjet line printer 1 ejects ink and forms dots on the recording medium 11, and records images (including text, symbols, and graphics) by the combination of dots. The basic operation for forming a dot on the recording medium 11 is described briefly using FIG. 1.

Forming a dot of a specific color at a desired position P1 on the recording medium 11 when the recording medium 11 is set to a position as shown in FIG. 1 is described below. The specific color is a color that is achieved by ejecting specific amounts of black (K), cyan (C), magenta (M), and yellow (Y) ink. Position P2 in FIG. 1 is the position where position P1 on the conveyed recording medium 11 passes the black nozzle line 20 of the upstream top recording head 17T. Position P3, position P4, and position P5 are similar positions.

The inkjet line printer 1 conveys the recording medium 11 in a specific direction at a predetermined constant speed while forming dots on the recording medium 11. Conveyance proceeds in the conveyance direction of the recording medium 11 from the position shown in FIG. 1, and the inkjet line printer 1 ejects a specific amount of black (K) ink timed to position P1 on the recording medium 11 reaching the position corresponding to position P2. The inkjet line printer 1 likewise ejects a specific amount of cyan (C) ink timed to position P1 on the recording medium 11 reaching the position corresponding to position P3, ejects a specific amount of magenta (M) ink timed to position P1 on the recording medium 11 reaching the position corresponding to position P4, and ejects a specific amount of yellow (Y) ink timed to position P1 on the recording medium 11 reaching the position corresponding to position P5. Specific amounts of black (K), cyan (C), magenta (M), and yellow (Y) ink are thus ejected to position P1 on the recording medium 11, and a dot of a specific color is formed at position P1.

With a inkjet line printer 1 according to this embodiment of the invention, the positions of the recording heads are fixed during the process related to recording an image, the recording medium 11 moves relative to the stationary recording heads, ink is desirably ejected from the recording heads to form dots, and an image is recorded.

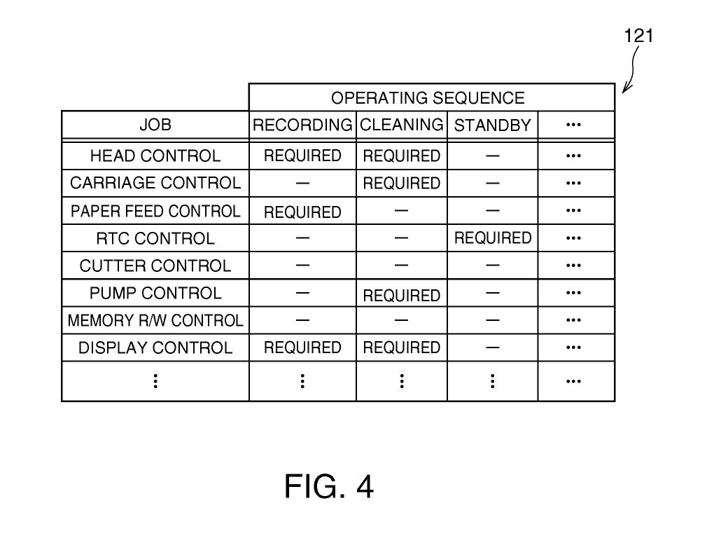

The upstream head unit 17 and the downstream head unit 18 are mounted on respective carriages (not shown). The carriages can be moved by the drive power of a carriage drive motor 37 (FIG. 4) described below between a recording above the recording medium 11, and respective home positions HP1 and HP2 disposed to a position removed from the recording medium 11.

The upstream head unit 17 is disposed to home position HP1 shown FIG. 1, and the downstream head unit 18 is disposed to home position HP2. The upstream head unit 17 and downstream head unit 18 move with the carriage (not shown) between the home positions HP1 and HP2 and the recording positions, and are set to the home positions HP1 and HP2 except when recording on the recording medium 11, that is, while in the standby mode.

Head cleaning mechanisms (not shown) for performing the flushing, cleaning, and nozzle check operations of the inkjet line printer 1 are disposed to the home positions HP1 and HP2. A separate head cleaning mechanism is located at each of the home positions HP1 and HP2. The head cleaning mechanisms disposed to home positions HP1 and HP2 each have a head cap that seals the nozzle face of the recording heads of the upstream head unit 17, a wiper for wiping ink and foreign matter from the nozzle face, and an ink suction unit that suctions ink left in or clogging the nozzles. This ink suction unit is connected to a pump motor 68 described below, and suctions ink by the suction force of the pump motor 68.

When recording by the upstream head unit 17 and downstream head unit 18 ends, the inkjet line printer 1 moves the upstream head unit 17 and downstream head unit 18 to the home positions HP1 and HP2, and covers the nozzles with the head cap of the head cleaning mechanism. This helps prevent ink left in the nozzles from drying and clogging the nozzles while in the standby mode.

The inkjet line printer 1 performs flushing, wiping, ink suction, and nozzle check operations as recording head 12 maintenance functions with the head cleaning mechanism. These operations are referred to as cleaning operations. A cleaning operation includes at least one of these operations, and may include a combination of plural different cleaning operations depending on the amount of cleaning that is required, that is, based on the degree of printing problems occurring with the recording head 12.

Flushing is an operation that removes ink that has increased in viscosity from the nozzles of the recording head 12 that have a low frequency of use or have not been used for a specific period of time so that dried or viscous ink does not create an ink ejection problem. To perform the flushing operation, the upstream head unit 17 is moved by the carriage to the home position HP1, and a specific amount of ink is discharged from some or all of the nozzles of each recording head 17L, 17R, 17T while the head cap is separated from the nozzle surface. The downstream head unit 18 is controlled in the same way for flushing at home position HP2.

Wiping is an operation that wipes the nozzle surface with a wiper disposed to the head cap at the home positions HP1 and HP2. Wiping removes particulate and ink from the nozzle surface, and helps maintain the ink meniscus in the nozzles.

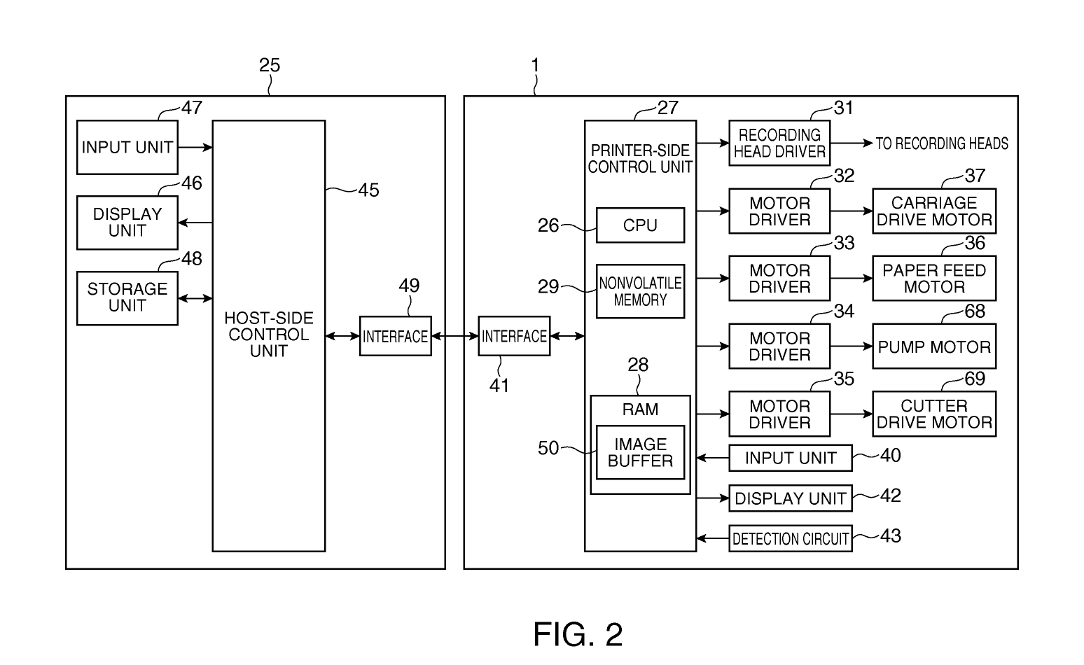

Ink suction is performed when head cleaning is required due to clogged nozzles. In this operation the nozzle surface is covered with the head cap, and negative pressure is produced by the suction of the pump motor 68 (FIG. 2) to pull ink from the nozzle openings into the head cap. This forces ink to flow from all nozzles of the recording head 12 and can eliminate clogged nozzles.

The nozzle check is an operation that tests defective nozzles, which are nozzles that are not ejecting normally due to clogging. The nozzle check discharges ink sequentially from each nozzle of the recording head 12 at the home positions HP1 and HP2. The ink is charged in the recording head 12, and defective nozzles are detected by detecting the current change produced by the ink landing on a detector disposed inside the head cap.

FIG. 2 is a function block diagram of an inkjet line printer 1 according to this embodiment of the invention, also showing a host computer 25 connected to the inkjet line printer 1.

The printer-side control unit 27 centrally controls parts of the inkjet line printer 1, and includes a CPU 26 as an operating unit, RAM 28 that temporarily stores the program executed by the CPU and data related to the program, nonvolatile memory 29 that nonvolatilely stores the basic control program that can be executed by the CPU 26 and related data, and other peripheral circuits. Both RAM 28 and nonvolatile memory 29 are devices as used herein.

Connected to the printer-side control unit 27 are driver circuits including a recording head driver 31 that drives the recording heads, a motor driver 32 that drives the carriage drive motor 37, a motor driver 33 that drives the paper feed motor 36, a motor driver 34 that drives the pump motor 68, and a motor driver 35 that drives the cutter drive motor 69.

The recording head driver 31 is connected to each recording head, and as controlled by the printer-side control unit 27 drives the actuators of each recording head to eject the required amount of ink from the nozzles.

Motor driver 32 is connected to the carriage drive motor 37. As controlled by the printer-side control unit 27, the motor driver 32 moves the upstream head unit 17 and/or the downstream head unit 18 from the position where the recording operation can be performed to the respective home position HP1, HP2, and from the home position HP1, HP2 to the position where the recording operation can be performed.

Motor driver 33 is connected to the paper feed motor 36, outputs a drive signal to the paper feed motor 36, and causes the paper feed motor 36 to operate only the amount specified by the printer-side control unit 27. As the paper feed motor 36 operates, the paper feed roller 10 turns, and the recording medium 11 is conveyed a specific amount in the conveyance direction or the reverse of the conveyance direction.

Motor driver 34 drives the pump motor 68 when cleaning the recording head 12 and when moving waste ink stored in the head cap to the waste ink tank.

Motor driver 35 drives the cutter drive motor 69 that operates the movable knife of the cutter unit (not shown in the figure) located downstream from the recording head 12 and cuts the recording medium 11. The cutter drive motor 69 is not limited to a motor and can be achieved using a solenoid, but is described below using a motor.

The recording head 12, paper feed motor 36, carriage drive motor 37, pump motor 68, and cutter drive motor 69 are all devices (operating units) as used herein.

A detection circuit 43, display unit 42, and input unit 40 are also connected to the printer-side control unit 27. These and components connected to these are also devices.

The detection circuit 43 is connected to a recording head temperature sensor 38. The recording head temperature sensor 38 is disposed near one of the recording heads, detects the temperature of the recording head, and outputs to the printer-side control unit 27. Based on the output from the recording head temperature sensor 38, the printer-side control unit 27 detects the temperature of the recording head.

The detection circuit 43 is also connected to a conductor disposed to the head cleaning mechanism (not shown in the figure) and detects landing of charged ink based on the current flow to the conductor.

The display unit 42 controls the on/off states of plural LEDs in the display unit 42 as controlled by the printer-side control unit 27. The input unit 40 outputs operating signals to the printer-side control unit 27 based on user operation of switches disposed to the input unit 40.

The communication interface 41 includes a connector that is connected to the host computer 25, and an interface circuit that implements a specific communication protocol through the connector. The communication interface 41 and the host computer 25 are connected using a standard such as IEEE 1284, USB (Universal Serial Bus), or IEEE 1394. Note that a configuration in which the communication interface 41 is connected to the host computer 25 through a LAN (local area network) using a wired or wireless communication path is also conceivable. In this case a plurality of host computers 25 could be connected to the inkjet line printer 1. The communication interface 41 is also a device.

The host computer 25 includes a host-side control unit 45, display unit 46, input unit 47, storage unit 48, and interface 49.

The host-side control unit 45 centrally controls the parts of the host computer 25, and includes a CPU, ROM, RAM, and peripheral circuits.

The display unit 46 is an LCD panel or OLED panel, for example, and displays information on the display panel as controlled by the host-side control unit 45.

The input unit 47 is connected to input devices, and outputs output signals from the input devices to the host-side control unit 45.

The storage unit 48 is a storage device such as a hard disk drive or EEPROM device, and stores data rewritably.

Like the communication interface 41 described above, the communication interface 49 communicates with the inkjet line printer 1 as controlled by the host-side control unit 45.

By reading and running the printer driver that controls the inkjet line printer 1, the host-side control unit 45 of the host computer 25 outputs control commands to the inkjet line printer 1 as needed. These commands include a group of commands such as commands telling the inkjet line printer 1 to print; control commands for conveying the recording medium 11; control commands for creating an image buffer 50 in a specific area in RAM 28 to store recording data, including text, symbols, images, and other content, to be recorded on the recording medium 11, and writing the recording data to the image buffer 50; and control commands for recording based on the image data stored in the image buffer 50.

The printer-side control unit 27 (recording control device) acquires this group of control commands input from the host computer 25, creates an operating sequence from the sequence of operations based on these commands, controls parts of the inkjet line printer 1, or more specifically the recording head driver 31 and motor drivers 33 and 34, by means of the printer-side control unit 27 according to this operating sequence, and performs the operation of recording an image on the recording medium 11.

While recording based on the control commands input from the host computer 25, the printer-side control unit 27 performs a cleaning operation including at least one of the flushing, wiping, ink suction, and nozzle check operations at a specific time interval or when specific conditions are met. To accomplish this the printer-side control unit 27 generates a cleaning operation sequence, and controls the motor drivers 32, 34 according to the operating sequence. When no other operation is performed after recording based on the control commands input from the host computer 25, or when a specific time has passed with no command input from the host computer 25, the printer-side control unit 27 enters a standby mode. The standby mode is another type of operating sequence. The printer-side control unit 27 generates an operating sequence before entering the standby mode, and controls the inkjet line printer 1 according to this operating sequence.

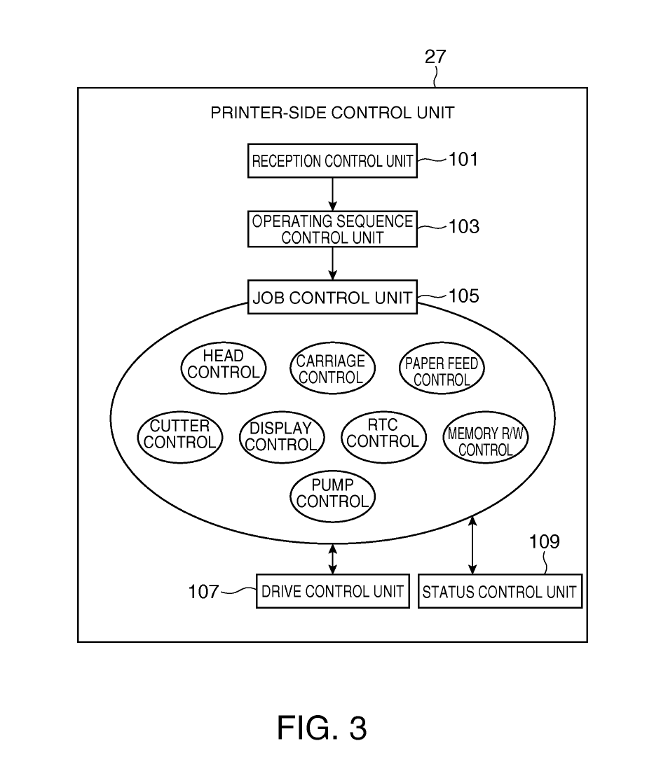

FIG. 3 shows the functional configuration of the printer-side control unit 27. The functional units shown in FIG. 3 are achieved by the CPU 26, RAM 28, and nonvolatile memory 29 of the printer-side control unit 27 by the CPU 26 running a control program.

The printer-side control unit 27 includes a reception control unit 101 that gets control commands and data input from the host computer 25 through the communication interface 41; an operating sequence control unit 103 (operating sequence control means) that determines the operating sequence based on the control commands and data acquired by the reception control unit 101; a job control unit 105 (job control means) that creates and deletes control jobs that control operating units of the inkjet line printer 1; a drive control unit 107 (drive control means) that runs the control jobs created by the job control unit 105 and operates the operating units; and a status control unit 109 that manages the status of the printer-side control unit 27.

An operating sequence created by the operating sequence control unit 103 combines a series of operations into a single unit, has the software processes and operations of the operating units included in the operating sequence arranged in the order executed by the smallest unit of operation, and may include operations to which the operating units do not contribute.

For example, the operating sequence of the recording operation that records a text or image on the recording medium 11 includes a process that writes the data to be recorded as an image in the image buffer 50; a process that converts the buffered image to an ink volume map for ejecting ink from the nozzles of the recording head 12; a process that drives the recording head 12, causes the paper feed motor 36 to turn, and conveys the recording medium 11; an operation that ejects ink from the nozzles of the recording head 12 according to the ink volume map; and a process that displays the operating status on the display unit 42. The operating sequence that cuts the recording medium 11 after recording includes an operation of driving the paper feed motor 36 and conveying the recording medium 11, and an operation of driving the cutter drive motor 69 and cutting the recording medium 11.

The operating sequence created by the operating sequence control unit 103 is not limited to actions controlled directly by a command acquired from the host computer 25 by the reception control unit 101. For example, a standby mode operating sequence is created when the standby mode is entered when a command has not been received from the host computer 25, or an operating unit is not driven for a specific period of time, after the recording operation has been completed and the recording medium 11 is cut. This standby mode operating sequence includes an operation that drives the carriage drive motor 37 and moves the recording head 12 to the home positions HP1 and HP2, and an operation that moves the head cap and caps the nozzle surface of the recording head 12. The inkjet line printer 1 is also configured to perform a cleaning operation when the recording head 12 is operated for at least a specific length of time in a recording operation, for example, and the operating sequence control unit 103 also generates an operating sequence for this cleaning operation.

The operating sequence control unit 103 thus also generates an operating sequence for operations that are performed automatically by the inkjet line printer 1 based on preset parameters, and not only when instructed by an external host computer 25 in a command acquired by the reception control unit 101.

The job control unit 105 creates control jobs that control operation by operating unit, primarily for the operations of the operating units that perform the smallest tasks (operations) in the operating sequence. The control job includes control content causing a single operating unit, which is a single mechanical element, to operate. For example, a control job for printhead control is a process executed by the drive control unit 107 to eject ink from the recording head 12, and is rendered by a program and control data.

The job control unit 105 can store control jobs that have been created. For example, a head control job is created when executing an operating sequence that causes the recording head 12 to operate. If this previously generated head control job has been saved, the head control job is executed by the drive control unit 107 when the recording head 12 is moved to perform the next operating sequence (such as cleaning).

The control jobs used in the operating sequence created by the operating sequence control unit 103 differ according to the type of operating sequence. Information about control jobs used in different operating sequences is stored in the job control unit 105.

The status control unit 109 monitors execution of control jobs created and stored by the job control unit 105, and checks whether the status of each control job is READY (standby mode) or BUSY (executing). This checking process is performed every time the control job performed by the drive control unit 107 changes.

FIG. 4 shows the relationship between control jobs and operating sequences, and more specifically shows the configuration of a control job table 121 relating control jobs to the operating sequences in which they are used. The control job table 121 is stored in nonvolatile memory 29, for example.

FIG. 4 shows an example of the control jobs that are used in three operating sequences, recording, cleaning, and standby. Because a control job can be created for every operating unit of the inkjet line printer 1, there are also control jobs that are created by the job control unit 105 and executed by the drive control unit 107 that are not shown in FIG. 4. For example, when the 1 has an actuator that drives the head cap, a control job that controls the actuator is also created and executed. The control job table 121 determines for all control jobs created by the job control unit 105 whether a particular control job is used in any particular operating sequence. These control jobs include control jobs related to software processes. In the example shown in FIG. 4, the memory read/write control job that controls reading and writing to nonvolatile memory 29, and the real-time clock (RTC) control job that keeps time using a timer function of the CPU 26 (FIG. 2), are examples of control jobs related to software processes.

The job control unit 105 can determine the control jobs to use in the operating sequence generated by the operating sequence control unit 103 based on the settings in the control job table 121. If a control job used in the operating sequence was previously created and stored, there is no need to create the control job again. If a control job to be used is a control job that is not stored by the job control unit 105, the job control unit 105 creates a new control job.

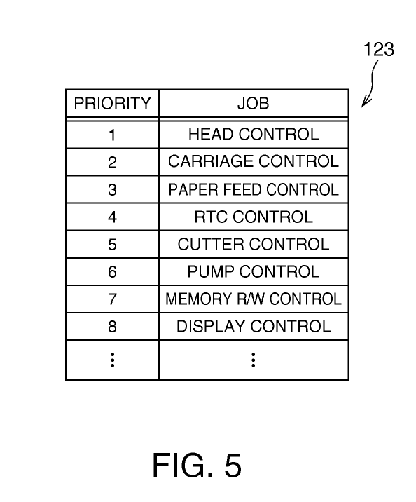

FIG. 5 shows the configuration of a priority table 123 that sets the priority level of each control job.

Each control job created by the job control unit 105 and run by the drive control unit 107 has an assigned priority setting. For example, if processing by the CPU 26 cannot keep pace, control jobs with a high priority setting are executed first and control jobs with a low priority level are delayed. In other words, resources are preferentially allocated to high priority control jobs. In the example shown in FIG. 5, control jobs related to controlling the recording head 12 have the highest priority. This is because print quality is affected when recording head 12 operation is interrupted. Control jobs related to carriage drive motor 37 control have the next highest priority because delaying the operation that seals the nozzle surface of the recording head 12 with the head cap could lead to clogged nozzles, and because the operation that moves the recording head 12 from the home positions HP1 and HP2 to the recording position directly above the recording medium 11 in order to start recording has priority over other operations.

The priority levels of the control jobs shown in FIG. 5 for example restrict operation of the drive control unit 107. More specifically, the drive control unit 107 does not execute control jobs by ignoring the priority setting, and changing the priority setting requires changing the setting with the job control unit 105.

The number of control jobs increases as the number of operating units (such as the recording head 12, motors, and actuators) in the inkjet line printer 1 increases. Because the control jobs stored by the job control unit 105 are in a format enabling execution by the drive control unit 107, the control jobs consume resources of the printer-side control unit 27, such as working space in RAM 28 that is used to execute the control jobs. In addition, because a priority level is assigned to each control job, the drive control unit 107 cannot execute only the required control jobs by ignoring existing control jobs, and executes each control job according to the assigned priority level. If there is a control job that does not require executing, the drive control unit 107 sets the job execution state to busy and then discards the control job to move on to the next control job. As a result, when there are numerous control jobs that are not used, time that is unrelated to executing the required control job is consumed by the process of managing control jobs that are not used. Furthermore, because the status control unit 109 performs the process of checking the status of each control job every time the control job status changes, the load of this process increases as the number of control jobs increases.

Therefore, to improve process efficiency, the job control unit 105 of the inkjet line printer 1 runs a process that deletes control jobs that are not used in the operating sequence created by the operating sequence control unit 103.

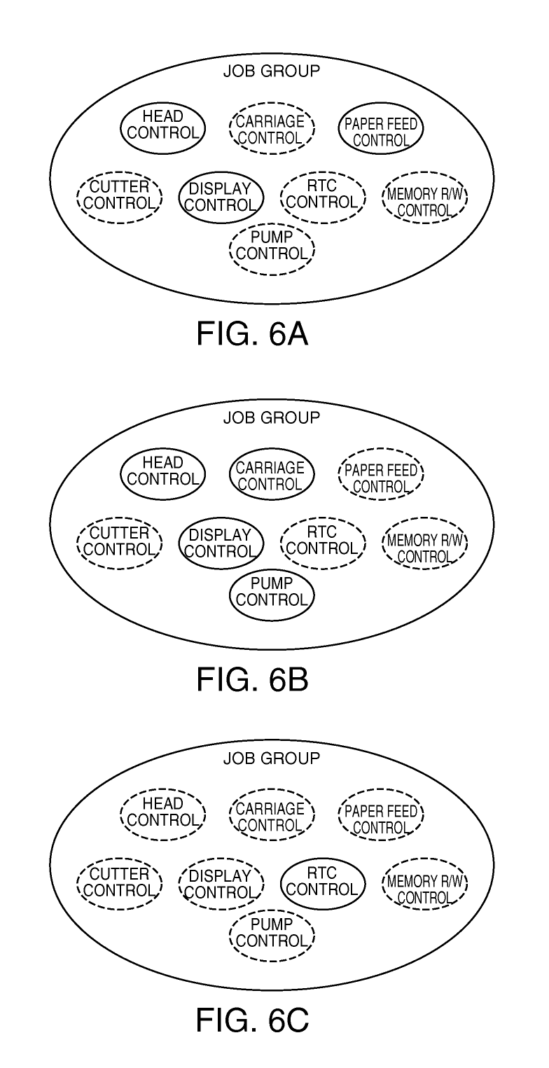

FIG. 6 describes creating and deleting control jobs in the operating sequences run by the printer-side control unit 27, (A) showing an example when running a recording operation, (B) showing an example of a cleaning operation, and (C) showing an example of the standby mode. FIG. 6 shows each of the control jobs shown in FIG. 3 to FIG. 5, but control jobs can be created for all operating units and software processes of the inkjet line printer 1, and are not limited to the control jobs shown for example in FIG. 6. This also applies to FIG. 3 to FIG. 5.

In FIG. 6 (A) to (C) solid lines indicate control jobs used in the operating sequence, and dotted lines indicate control jobs that are not used.

As shown in FIG. 6 (A), control of the recording head 12, control of the paper feed motor 36, and display control of the display unit 42 are involved when recording to the recording medium 11. Based on the control job table 121 (FIG. 4), the job control unit 105 creates at least three control jobs, that is, head control (related to the recording head 12), paper feed control (related to the paper feed motor 36), and display control (related to the display unit 42). If these control jobs were already created and stored in the job control unit 105, creating new jobs is not required. Other control jobs, such as carriage control (related to the carriage drive motor 37) and cutter control (related to the cutter drive motor 69), are not used, and the job control unit 105 therefore deletes the unused control jobs.

Likewise, to perform a cleaning operation as shown in FIG. 6 (B), control jobs for head control, carriage control, and pump control (related to the pump motor 68), and display control are used based on the settings in the control job table 121. The job control unit 105 creates any missing control jobs so that at least all of the control jobs are ready.

In the standby state shown in FIG. 6 (C), a control job for RTC control is used in order to count the time until the standby mode is entered.

The job control unit 105 can also delete all of the control jobs shown in dotted lines in FIG. 6 (A) to (C). By reducing the number of control jobs stored by the job control unit 105, that is, the number of control jobs that can be readily executed by the drive control unit 107 (that are READY or BUSY), unused resources can be freed as described above, the process of the status control unit 109 checking the status of each control job can be simplified, and the task of setting control jobs that are not necessary based on their priority level to BUSY and then dispatching the jobs can be eliminated. However, if a control job that is not used is set to READY, the process of deleting and then recreating the control job when the control job is used in a next operating sequence can be omitted. Considering these competing advantages, the job control unit 105 could operate in the following two ways.

The first operation is an operation whereby every time an operating sequence created by the operating sequence control unit 103 is acquired, the job control unit 105 deletes all control jobs that are not used. This has the effect of removing processes and freeing resources related to unnecessary control jobs.

The second operation is an operation whereby the job control unit 105 deletes all or part of the control jobs that are not used so that the total number of control jobs does not exceed some threshold. In addition to the benefit obtained by not deleting control jobs, this method improves processing efficiency because the burden of processing and the resources that are consumed by unnecessary control jobs can be suppressed to a specific level or below. This second method enables achieving both of the competing advantages described above. Deleting control jobs in order from the control jobs with the highest priority is also conceivable with this second method. This method is particularly advantageous because there is a strong possibility of being able to omit the operation of setting unnecessary control jobs to BUSY and then dispatching the jobs.

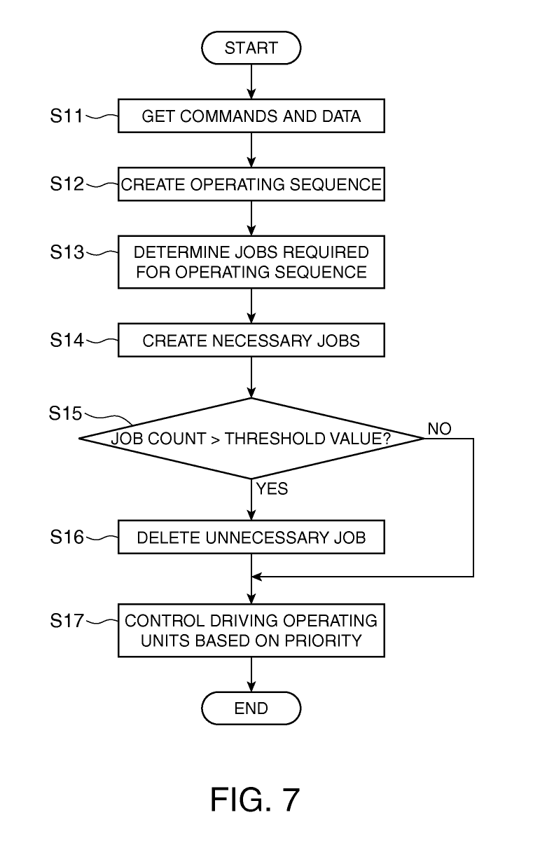

FIG. 7 is a flow chart of inkjet line printer 1 operation, particularly the operation of the printer-side control unit 27.

The reception control unit 101 of the printer-side control unit 27 first acquires the commands and data sent from the host computer 25 (step S11). The operating sequence control unit 103 then generates an operating sequence based on the commands and data acquired by the reception control unit 101 (step S12).

The job control unit 105 then acquires the operating sequence generated by the operating sequence control unit 103, and identifies the control jobs used in the operating sequence by, for example, referencing the control job table 121 (step S13).

The job control unit 105 creates a control job for any control job identified in step S13 that has not been created (step S14). The job control unit 105 then determines if the total number of control jobs resulting from creating the required control jobs exceeds the threshold level (step S15). If the number of control jobs exceeds the threshold (step S15 returns Yes), the job control unit 105 deletes the control jobs that are not used (step S16). Note that the number of control jobs deleted is determined so that the number of control jobs is less than the threshold number even after all required control jobs are generated in step S14.

The drive control unit 107 then executes the control jobs used in the operating sequence sequentially or in parallel (step S17), and this process ends.

If the job control unit 105 determines that the number of control jobs does not exceed the threshold even after the required control jobs are created in step S14 (step S15 returns No), control skips directly to step S17.

As described above, an inkjet line printer 1 with plural devices according to this embodiment of the invention has an operating sequence control unit 103 that generates an operating sequence of specific operations performed by the inkjet line printer 1, a job control unit 105 that stores device control jobs based on the operating sequence, and a drive control unit 107 that drives devices by executing the control jobs. When the control jobs that are used are stored in a control job table 121 in the job control unit 105 according to the type of operating sequence created by the operating sequence control unit 103, and the operating sequence control unit 103 creates an operating sequence, the job control unit 105 references the control jobs related to the type of the operating sequence, creates a new control job for any control job used in the operating sequence that was not already created, and deletes at least one control job that is not used when there are control jobs that are not used in the operating sequence.

Because a new control job is thus created when a control job that is used in the operating sequence has not been created, and at least one control job is deleted when there are control jobs that are not used, resources that are occupied by unnecessary control jobs can be freed, and resources can be used effectively for executing the necessary control jobs. As a result, efficient control is possible without processing being delayed when the process load is high, such as when there is a large amount of data to process, or the inkjet line printer 1 has many devices and control is complicated.

In addition, because the job control unit 105 deletes control jobs that are not used so that the number of control jobs does not exceed a threshold number, more resources can be reliably allocated to the control jobs to be run, process delays caused by insufficient resources can be prevented, and high speed processing is possible.

In addition, because the priority of execution is set for each of the created control jobs as shown in the priority table 123, for example, and the drive control unit 107 executes the plural control jobs sequentially or in parallel based on the priority level set for each control job, deleting control jobs that are not used enables omitting a process whereby the job control unit 105 changes the priority setting of control jobs that are unnecessary but have a high priority level, and enables omitting a process whereby whether or not to execute a control job is determined after setting the job status to BUSY, and control jobs that are not executed are discarded based on this decision. As a result, the processes needed to manage control jobs can be reduced, and the inkjet line printer 1 can be controlled more efficiently.

In addition, because the operating sequence control unit 103 generates an operating sequence based on control commands and the data to be recorded that are input from the inkjet line printer 1, the inkjet line printer 1 can be efficiently controlled based on the control commands and data input from the host computer 25 to the inkjet line printer 1.

Yet further, because the devices of the inkjet line printer 1 include a recording head and actuators, and the job control unit 105 creates one control job for one device, devices can be reliably controlled by generating one control job for one operating unit, and even an inkjet line printer 1 with many operating units can be efficiently controlled by deleting unnecessary jobs.

The foregoing embodiments describe preferred embodiments of the invention, and can be modified and applied as desired without departing from the scope of the invention.

For example, a configuration in which control job priority settings are stored as a priority table 123 by the job control unit 105 is described in the foregoing embodiment, but the invention is not so limited and any configuration that assigns a priority value to each control job can be used. For example, a configuration that enables setting job priority relative to the priority of another control job is also conceivable, and consecutive values are not required. A configuration that sets a parameter indicating the priority of each control job, and enables the drive control unit 107 to select control jobs by order of highest priority based on the relative value of this parameter, is also conceivable. In addition, the foregoing embodiment describes an inkjet line printer 1 as an example of a recording device with a line head having a recording head 12 that covers the width of the recording area on the recording medium 11, but the invention is not so limited. More specifically, the invention can be broadly applied to recording devices that record on a recording medium by operating an operating unit, including inkjet printers, dot impact printers, thermal transfer printers, dye sublimation printers, laser printers, and other printers that record by scanning the recording area with a printhead.

Some of the function blocks of the inkjet line printer 1 and host computer 25 shown in FIG. 2, and function blocks of the printer-side control unit 27 shown in FIG. 3, are achieved by the cooperation of hardware and software, the function blocks do not limit the particular hardware configuration, and configurations that combine the functions of plural function blocks into one function block are also conceivable. In addition, configurations in which the programs stored in nonvolatile memory or a storage unit in the foregoing embodiment are stored in nonvolatile memory not shown, or are stored on a removable recording medium, or are stored downloadably from another device connected over a communication connection, and which enable the inkjet line printer 1 or host computer 25 to download and run the programs from any of these devices, are also conceivable. Other aspects of the foregoing configurations can also be changed as desired.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A recording device having plural devices, and comprising:
an operating sequence control unit that creates an operating sequence based on specific operations to be executed;
a drive control unit that drives the device by executing a control job; and
a job control unit that creates a control job for the device based on the operating sequence,
stores the control jobs that are used based on the type of operating sequence created by the operating sequence control unit, and
when the operating sequence control unit creates the operating sequence, references the stored control job corresponding to the type of operating sequence, creates a new control job when the control job used in the operating sequence has not been created, and deletes at least one control job when there is a control job that is not used in the operating sequence.

2. The recording device described in claim 1, wherein:
the job control unit deletes control jobs that are not used so that the number of created control jobs does not exceed a specific threshold.

3. The recording device described in claim 1, wherein:
a priority of execution is set for the control jobs created by the job control unit; and
the drive control unit executes the plural control jobs sequentially or in parallel according to the priority set for each control job.

4. The recording device described in claim 1, wherein:
the operating sequence control unit creates the operating sequence based on data to be recorded and a control command input to the recording device.

5. The recording device described in claim 1, wherein:
the devices include a recording head or actuator; and
the job control unit creates one control job for one device.

6. A method of controlling a recording device having plural devices, comprising steps of:
creating an operating sequence of specific operations executed by the recording device;
referencing previously stored control jobs based on the type of operating sequence created, creating a new control job when the control job used in the operating sequence has not been created, and deleting at least one control job when there is a control job that is not used in the operating sequence; and
driving the device by executing the control job.

7. The method of controlling a recording device described in claim 6, wherein:
the job control unit deletes control jobs that are not used so that the number of created control jobs does not exceed a specific threshold.

8. The method of controlling a recording device described in claim 6, wherein:
a priority of execution is set for the control jobs created by the job control unit; and
the plural control jobs are executed sequentially or in parallel according to the priority set for each control job.

9. The method of controlling a recording device described in claim 6, wherein:
the operating sequence is created based on data to be recorded and a control command input to the recording device.

10. The method of controlling a recording device described in claim 6, wherein:
the devices include a recording head or actuator; and
one control job is created for one device.

11. A computer-readable storage medium storing a program that can be executed by a control unit that controls the devices of a recording device having plural devices, the program causing the control unit to function as:
a drive control unit that drives the device by executing a control job created for each device;
an operating sequence control unit that creates an operating sequence of specific operations executed by the recording device; and
a job control unit that stores the control jobs that are used based on the type of operating sequence created by the operating sequence control unit, and
when the operating sequence control unit creates the operating sequence, references the stored control job corresponding to the type of operating sequence, creates a new control job when the control job used in the operating sequence has not been created, deletes at least one control job when there is a control job that is not used in the operating sequence, and stores the control jobs.
